(19) United States
(12) Patent Application Publication
(10) Pub. No.: US 2019/0265054 A1
(43) Pub. Date: Aug. 29, 2019

(54) PASSENGER TRANSPORT ROUTE MANAGEMENT SYSTEM AND METHOD

(71) Applicant: ENTREPRISES WYHN INC., La Peche (CA)

(72) Inventors: Dominic Laplante, La Pêche (CA); Kevin Lanthier, Gatineau (CA); Alexandre Clement, Gatineau (CA)

(73) Assignee: ENTREPRISES WYHN INC.

(21) Appl. No.: 16/287,321

(22) Filed: Feb. 27, 2019

Related U.S. Application Data
(60) Provisional application No. 62/636,264, filed on Feb. 28, 2018.

(51) Int. Cl. G01C 21/34; G06F 16/29; G01C 21/36

(52) U.S. Cl. CPC G01C 21/3438; G01C 21/362; G01C 21/3676; G06F 16/29

(57) ABSTRACT

Described are various embodiments of a passenger transport route management system and method. In one embodiment, a vehicular route management system for managing a set of predefined routes to be repetitively executed by a corresponding set of vehicles is described. The system illustratively comprises: a respective onboard user terminal; a network-accessible server operatively associated with a communication interface, a digital data processor and a data storage device. The server directly or indirectly links with each onboard user terminal via the communication interface to process route tracking data to automatically generate and dispatch a revised digital version of a given route based on identified deviations.

### CROSS REFERENCE TO RELATED APPLICATIONS

This application claims the benefit of U.S. Provisional Application No. 62/636,264 filed Feb. 28, 2018, which is incorporated herein by reference in its entirety.

### FIELD OF THE DISCLOSURE

The present disclosure relates to transportation systems, and, in particular, to a passenger transport route management system and method.

### BACKGROUND

Passenger transportation systems generally rely on the establishment of designated routes and travel itineraries to allow passengers to share transportation means between one or more pick-up and drop-off locations. These may include public and private transport systems for communal buses, shuttles, cars and like vehicles traveling on private, public and/or dedicated roads, laneways, transitways and other such vehicular local, regional, municipal, provisional, and even larger transit networks.

One common passenger transport system involves the transport of children to and from school generally by means of a network school buses and routes relaying children from different pick-up locations to one or more assigned school drop-off locations. Typically, school buses travel along set routes, passing from house to house or from bus stop to bus stop, stopping to pick up or discharge students at designated times. However, those transportation systems are still managed using paper and/or phone/fax-based communication means to manage the plurality of bus routes and coordination between drivers and dispatchers. These methods are highly inefficient and result in higher costs, higher fuel usage and late arrivals, for example.

Moreover, school buses do not always arrive at the pre-designated stops on time, as a result of traffic conditions, weather, or the like. In the winter season especially, and/or when raining, children sometimes have to suffer harsh weather conditions for a half hour or longer while waiting for the school bus at a school bus stop.

Sometimes, one or more buses may not be able to service their designated route, due to a mechanical failure, medical emergency, harsh weather or traffic. In such cases, it is difficult for dispatchers to reassign transportation resources quickly to assure an efficient transportation service for all students.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for a passenger transport route management system and method that overcome some of the drawbacks of known techniques, or at least, provides a useful alternative thereto. Some aspects of the herein described embodiments provide examples of such systems and methods. In particular, one such aspect provides a (school) bus route management system and method, whereby automated route creation, optimization, redistribution and/or tracking may be invoked, for instance to provide real-time monitoring and/or optimization strategies in a (school) bus transportation network. Similar examples may also be applied to other passenger transport systems, such as public or private bus, shuttle or like transit systems where designated routes are repeatedly travelled to service a plurality of designated pick-up and/or drop-off locations, in some instances, based on a designated schedule/itinerary.

For example, in accordance with one aspect, there is provided a vehicular route management system for managing a set of predefined routes to be repetitively executed by a corresponding set of vehicles, the system comprising: a respective onboard user terminal operable from within each of the vehicles and operably linked to a corresponding global positioning system (GPS) receiver to acquire route tracking data as a given vehicle travels along a given predefined route; a network-accessible server operatively associated with a communication interface, a digital data processor and a data storage device, said server directly or indirectly linking with each said onboard user terminal via said communication interface to process said route tracking data to automatically: generate a digital route mapping for said given route based on said route tracking data; identify deviations in said digital route mapping from said given predefined route representative of corresponding route deviations executed by said given vehicle during travel along said given predefined route; generate a revised digital version of said given route based on said identified deviations; and dispatch said revised digital version to said onboard user terminal to be followed during subsequent travel along said given predefined route.

In one embodiment, the server is operable to generate and store said revised digital version of said given route as a persistent data structure.

In one embodiment, the persistent data structure is a persistent binary search tree.

In one embodiment, each said given predefined route comprises a plurality of pick-up locations and at least one drop-off location.

In one embodiment, the system is a school bus route management system, wherein each of said pick-up locations is digitally associated with at least one student profile corresponding with a student to be picked up at said pick-up location.

In one embodiment, the GPS receiver is integrated within said onboard user terminal.

In one embodiment, the onboard user terminal comprises a graphical user interface (GUI) operable to display elements of said given route.

In one embodiment, the onboard user terminal comprises or is operatively associated with a tablet or smartphone device.

In one embodiment, the onboard user terminal is operable to deny said revised digital version in favour of a previous version.

In one embodiment, the revised route is selectively dispatched in response to an administrator action interactively executed via said server.

In accordance with another aspect, there is provided a computer-implemented to process for managing a set of predefined routes to be repetitively executed by a corresponding set of vehicles, the process comprising: acquiring, via an onboard user terminal, digital route tracking data as a given vehicle travels along a given predefined route; generating, via a server communicatively linked to said onboard user terminal, a digital route mapping for said given route based on said route tracking data; automatically identifying deviations in said digital route mapping from said given predefined route representative of corresponding route deviations executed by said given vehicle during travel along said given predefined route; automatically generating a revised digital version of said given route based on said identified deviations; and communicatively dispatching said revised digital version to said onboard user terminal to be followed during subsequent travel along said given predefined route.

In one embodiment, the revised digital version of said given route is stored as a persistent data structure.

In one embodiment, the persistent data structure is a persistent binary search tree.

In one embodiment, each said given predefined route comprises a plurality of pick-up locations and at least one drop-off location.

In one embodiment, the process is a school bus route management process, wherein each of said pick-up locations is digitally associated with at least one student profile corresponding with a student to be picked up at said pick-up location.

In one embodiment, automatically identifying deviations in said digital route mapping comprises automatically identifying a travel path deviation between two successive pick-up locations.

In one embodiment, automatically identifying deviations in said digital route mapping comprises automatically identifying a re-ordering at least two of said pick-up locations thereby resulting in a corresponding travel path deviation.

In one embodiment, the revised digital version is selectively denied in favour of a previous version via a user interface of said onboard user terminal.

In one embodiment, the revised route is selectively dispatched in response to an administrator action interactively executed via said server.

In accordance with another aspect, there is provided a vehicular route management system for managing a set of predefined routes to be repetitively executed by a corresponding set of vehicles, the system comprising: a plurality of onboard user terminals operable from within respective vehicles as they travel on respective routes, wherein each of said terminals is operatively associated with: a global positioning system (GPS) receiver to track a corresponding vehicle as it travels along a designated route; a graphical user interface (GUI) to preview and display vehicular travel along said designated route; and a wireless communication interface; a network-accessible server operatively associated with a digital data processor, a data storage device and an input interface; wherein said data storage device has stored in association therewith designated route data representative of each of said respective routes and defining for each one thereof a prescribed vehicle, a plurality of pick-up locations, at least one drop-off location and a predefined geographic path mapping sequence and timing therebetween; wherein, upon identification that a given prescribed vehicle will not complete a given designated route, said digital processor automatically: identifies affected pick-up locations associated with said given designated route; identifies at least one distinct route associated with a distinct vehicle that is alterable to take on said affected pick-up locations; temporarily redistributes said affected pick-up locations amongst said at least one distinct route by automatically redefining said predefined geographic path mapping sequence respectively associated therewith to include said affected pick-up locations; and dispatches each said automatically redefined geographic path mapping sequence to each said distinct vehicle.

In one embodiment, the digital data processor redistributes said affected pick-up locations based at least in part on at least one of a geographical proximity of said distinct route to said affected pick-up locations, an available transport capacity of said distinct vehicle or a temporal availability of said distinct vehicle as determined from said timing of said designated route associated therewith.

In one embodiment, the affected pick-up locations are redistributed amongst at least two said distinct route.

In one embodiment, the affected pick-up locations define a subset of said plurality of pick-up locations associated with the given vehicle.

In one embodiment, the identification is associated with a vehicular breakdown during completion of said given designated route, and wherein said processor redistributes said affected pick-up locations in real-time.

In one embodiment, the identification is associated with a reported unavailability of said given prescribed vehicle.

In one embodiment, the identification is associated with a traffic report prohibiting completion of said given designated route.

In one embodiment, the processor further automatically dispatches a notification to individuals associated with each of said affected pick-up locations.

In one embodiment, the processor further automatically dispatches a notification to individuals associated with said drop-off location associated with each of said affected pick-up locations.

In one embodiment, upon said identification occurring during execution of said given designated route, said automatically redefined geographic path mapping sequence comprises a bulk passenger pick-up event from said given vehicle to complete their transit.

In accordance with another aspect, there is provided a computer-implemented vehicular route management process for managing a set of predefined routes to be repetitively executed by a corresponding set of vehicles, the process comprising: allocating respective designated route data to each of said predefined routes defining for each one thereof a prescribed vehicle, a plurality of pick-up locations, at least one drop-off location and a predefined geographic path mapping sequence and timing therebetween; upon identifying that a given prescribed vehicle will not complete a given designated route; identifying affected pick-up locations associated with said given designated route; identifying at least one distinct route associated with a distinct vehicle that is alterable to take on said affected pick-up locations; temporarily redistributing said affected pick-up locations amongst said at least one distinct route by automatically redefining said predefined geographic path mapping sequence respectively associated therewith to include said affected pick-up locations; and dispatching each said automatically redefined geographic path mapping sequence to each said distinct vehicle for implementation via a respective onboard user terminal.

In one embodiment, the redistributing is based at least in part on at least one of a geographical proximity of said distinct route to said affected pick-up locations, an available transport capacity of said distinct vehicle or a temporal availability of said distinct vehicle as determined from said timing of said designated route associated therewith.

In one embodiment, the affected pick-up locations are redistributed amongst at least two said distinct route.

In one embodiment, the affected pick-up locations define a subset of said plurality of pick-up locations associated with the given vehicle.

In one embodiment, the identification is associated with a vehicular breakdown during completion of said given designated route, and wherein said processor redistributes said affected pick-up locations in real-time.

In one embodiment, the identification is associated with a reported unavailability of said given prescribed vehicle.

In one embodiment, the identification is associated with a traffic report prohibiting completion of said given designated route.

In one embodiment, the process further comprises automatically dispatching a notification to individuals associated with each of said affected pick-up locations.

In one embodiment, the process further comprises automatically dispatching a notification to individuals associated with said drop-off location associated with each of said affected pick-up locations.

In one embodiment, upon said identification occurring during execution of said given designated route, said automatically redefined geographic path mapping sequence comprises a bulk passenger pick-up event from said given vehicle to complete their transit.

Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1 is a schematic diagram of a route management system, in accordance with one embodiment;

FIG. 2 is a schematic diagram of an exemplary route recording and versioning process to be implemented using a route management system as exemplarily illustrated in FIG. 1, in accordance with one embodiment; and

FIG. 3 is a schematic diagram of an exemplary real-time route redistribution process operable using a route management system as exemplarily illustrated in FIG. 1, in accordance with one embodiment.

Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Various apparatuses and processes will be described below to provide examples of implementations of the system disclosed herein. No implementation described below limits any claimed implementation and any claimed implementations may cover processes or apparatuses that differ from those described below. The claimed implementations are not limited to apparatuses or processes having all of the features of any one apparatus or process described below or to features common to multiple or all of the apparatuses or processes described below. It is possible that an apparatus or process described below is not an implementation of any claimed subject matter.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” may be construed as X only, Y only, Z only, or any combination of two or more items X, Y, and Z (e.g., XYZ, XY, YZ, ZZ, and the like). Similar logic may be applied for two or more items in any occurrence of “at least one . . . ” and “one or more . . . ” language.

The systems and methods described herein provide, in accordance with different embodiments, different examples of a passenger transport route management system and process, for example, a (real-time) school bus route management system and method. For example, and as will be detailed further below, some of the embodiments considered herein invoke a system in which a passenger (including schoolchildren) transportation process involving a fleet of (school) buses is managed and monitored in real-time, while also providing for real-time routing optimizations to promote increased reliability, driver productivity and/or fuel-efficient driving, to name a few possible advantages/benefits. In the following examples, focus will be directed on a school bus route management system and process, thought it will be appreciated that other passenger road transport systems may also be contemplated, for example, where designated routes, pick-up and/or drop-off locations are maintained and repeatedly followed on a regular basis (e.g. private or public shuttle, but or transit route system, etc.).

In some embodiments, route management features are supported by a companion artificial intelligence (AI) system configured to provide advanced automated or semi-automated optimization strategies, such as for example, providing for automated or semi-automated route, tracking, versioning, improvement, reallocation and/or redistribution amongst different drivers, vehicles, etc. Different AI, machine learning and/or system automation techniques may be considered, as will be discussed further below.

In general, the systems described herein comprise a server-based software program, operable to monitor in real-time the transportation process of schoolchildren (or other passengers) from designated pick-up locations to one or more designated drop-off locations, provide real-time information to a plurality of users about said transportation process and offers real-time route optimization strategies for authorized users. As will be explained below, each system user (student, parent, driver, dispatcher, school board administrator, daycare, teacher, etc.) may use a user terminal to access a selection of features provided by said program.

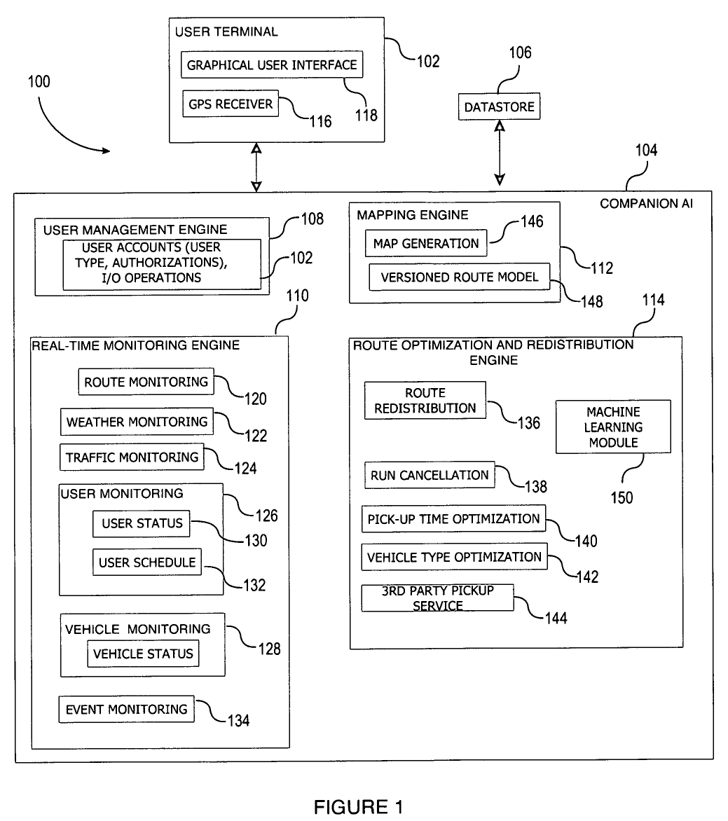

With reference to FIG. 1, and in accordance with one exemplary embodiment, a school bus management system, generally referred to using the numeral 100, will now be described. In the illustrated embodiment, the system 100 is configured to provide monitoring and optimization of a schoolchildren bus transportation network, though similar applications may be applied to other routine transportation networks and systems. In the illustrated embodiment, the system 100 generally comprises a plurality of user terminals 102 connected to a server-based Companion AI software platform 104. The AI companion platform or software program 104 is further operationally connected to a data store 106 and illustratively comprises a User Management Engine (UME) 108, a Real-Time Monitoring Engine (RTME) 110, a Mapping Engine (ME) 112 and a Route Optimization and Redistribution Engine (RORE) 114. The nature of these components, in some embodiments, will be described below.

In some embodiments, the server-based companion AI 104 runs continuously on a processor operationally connected to a data store device. It will be appreciated that the digital processor may take various forms, which may include, but is not limited, a dedicated computing or digital processing device, a general computing device, tablet and/or smartphone interface/application, and/or other computing device as may be readily appreciated by the skilled artisan. Furthermore, the data store 106 is operable to store any data recorded by any system component of the AI companion 104. This recorded data may also be used autonomously by different system components, as will be described below. The data store 106 may be comprised of one or more databases for storing the relevant data, which may include network accessible databases or any number of related and/or interfacing data storage structures and media without departing from the general scope and nature of the present disclosure.

As mentioned above, the system 100 also generally comprises a plurality of user terminals 102 connected to the server-based companion AI 104. This user terminal 102 may take various forms, which may include, but is not limited, a dedicated computing or digital processing device, a general computing device, tablet and/or smartphone interface/application. The user terminal 102 may be operationally connected to the server-based AI companion 104 through the use of a wired or wireless network connection. The skilled artisan will understand that a different means of connecting an electronic device such as the user terminal wirelessly to a server-based platform may exist, including Wi-Fi, Bluetooth, Cellular, 2G, 3G, 4G and similar.

In some embodiments, a global positioning system (GPS) receiver 116 is embedded in the user terminal 102 for monitoring purposes, while in other embodiments the GPS receiver may be part of a separate hardware sensor module (not shown). This device may, in some embodiments, comprise additional sensors (e.g., cameras, sound recorders, etc.) in addition to the GPS receiver 116 and may be operationally linked to the user terminal 102 or directly to data store 106. In some embodiments, the user terminal 102 may be operable to use a push-to-talk (PTT) or Push-to-talk over cellular (PoC) method wherein a user may communicate with another user via two-way radio (e.g., CB radio). In other embodiments, the functionality of user terminal 102 may be implemented as a software application to be installed on smartphone or tablet-like devices. For example, the user terminal 102 of a bus driver user may comprise an application installed on a phone or tablet-like device with access to a cellular data network, said phone or tablet-like device affixed to or near the dashboard of the bus. In another example, a separate electronic device comprising a GPS receiver and/or other sensors may also be affixed elsewhere inside or outside the bus for tracking purposes and connected to the user terminal by wired or wireless means.

In some embodiments, the user terminal 102 further comprises a graphical user interface (GUI) 118 for displaying or receiving data. Each user type may be to presented with a different GUI version, wherein each GUI configuration is optimized for a certain number of tasks and/or authorization levels. For example, a bus driver may be presented with a map, including a set of driving directions, representing a route to follow during a specified run. Along each route, the set of pick-up and drop-off points is illustrated. The GUI 118 may also show notifications about points of interest or hazards along the illustrated path. Similarly, a dispatcher logged-in to the system may be presented with a map including an overview of the fleet of vehicles active at a given time, their position and any other parameter monitored by the RTME 110. The nature of these parameters will be explained in detail further below. Finally, users such as students or parents may be limited, in some embodiments, to viewing the location of each bus in real-time and the location of the designated pick-up points and the estimated bus arrival time.

In some embodiments, different users may use their user terminal 102 to communicate with one another (via text or voice). Private or group conversation features may also be provided.

Other ways of visualizing information and interacting with the user terminal 102, such as using augmented reality (AR) or virtual reality (VR) devices may be used. For example, in some embodiments, user terminal 102 may further comprise an augmented reality (AR) head-up display (HUD) (not shown). In some embodiments, this may be implemented in the form of a transparent OLED film superimposed on the transportation vehicle windshield, coupled with a camera device or similar. Other types of VR/AR devices, such as a headset, glasses or similar may also be used. Different visualization features may be used, depending on the user type. These include, for example, displaying directions, notifications, regulatory signs (e.g., traffic signs), warning cues for potential hazards and the location of points of interest (e.g, pick-up/drop-off location, school location, etc.) without having drivers take their eyes away from the road.

In some embodiments, the User Management Engine (UME) 108 manages, in some embodiments, user accounts (e.g., login and password information), user profiles, authorization levels and I/O between user terminal 102 and Companion AI 104. In some embodiments, different user categories may be defined. These may include, but are not limited to, bus drivers, bus company operators/supervisors, dispatchers, school or school board administrators, children, their parents or legal guardians. These categories may have access, in some embodiments, to different types of terminal devices. These may differ in the input method used. For example, in the case of a bus driver, the user terminal may use simple touch-based gestures or voice recognition methods for input, while a dispatcher or school-board administrator may have access to a device operable to receive commands using a keyboard device or similar.

In general, different user categories may receive different authorization levels. These authorization levels control the type of data that may be viewed and/or modified, including the ability to accept or refuse run/route modification suggestions generated by RORE 114. For instance, an authorized user, such as a school-board administrator would likely have access to detail information about the plurality of bus routes in the system, bus runs in progress, route/run modification suggestions, or other types of data being monitored by the RTME 110, as discussed below. In contrast, a student or parent may only have access to more limited or individualized information such as the real-time location of his/her designated bus, pick-up point, expected arrival time or similar. He or she may also change his/her status (e.g., not going to school that day, etc). The skilled artisan will understand that different types of authorization levels may be used.

Moreover, the UME 108 may also manage a plurality of user profiles, each profile compiling important information concerning that user. For example, a student profile may contain his/her assigned school, school schedule, health profile (e.g., medical condition, allergies, etc.), notifications about bad behaviour, emergency contact information and information about any special needs (e.g., wheelchair access, etc.). A driver may be authorized to view the information concerning each student he/she has to provide transportation to. In contrast, a driver's profile may contain information about his/her currently assigned work schedule, the log-in/log-out times, the total time or distance driven for a given time period (day, week, month or similar). Other profile types and/or important information may be added.

Still referencing FIG. 1, the Real-Time Monitoring Engine (RTME) 110 is operable to monitor in real-time a plurality of parameters of interest characterizing the transportation process. Different parameters of interest monitored by the RTME 110 may include, but are not limited to route monitoring (120), weather monitoring (122), traffic monitoring (124), user monitoring (126), vehicle monitoring (128) and critical event monitoring (130). The skilled artisan will understand that other parameters that affect the logistics of the school bus transportation process may also be monitored.

In some embodiments, the Route Monitoring (120) feature comprises, in part, recording the position and speed of each individual bus driving along an assigned route in real-time, using the data acquired by GPS receiver 116 for example to record both travel times, distances and locations, but also routine or unusual stops/delays. Other route-related data that may also be monitored includes the degree of completion of each bus run, recorded divergences from the assigned route map (using the GPS coordinates), changes from the expected average speed, missed pick-up/drop-off times, or similar. In some embodiments, a run may be considered completed when the driver manually logs off via his/her user terminal or when a designated amount of time has passed without the bus moving. For example, if no movement is recorded with the GPS receiver and that 30 minutes have passed, the bus is considered permanently stopped and the run monitoring is ended. In order examples, a bus that has been immobilized for an extended period with driver signoff may be triggered to automatically dispatch an alert or notification, for example, to trigger further investigation (e.g. bus breakdown, driver medical condition, road hazard, unusual traffic patters, etc.)

The Route Monitoring 120 may further comprise a route recording feature. When in use by the RTME 110, a bus driver may freely choose to ignore the assigned route in the case of a traffic accident or hazard blocking the path, or because the driver believes he/she knows a more efficient and/or safe way of reaching a pickup or drop-off location than the one provided by the system. Since the trajectory of the vehicle is monitored in real-time, any deviation from the assigned route will be recorded. Finally, the driver may, using his user terminal, manually add one or more pickup or drop-off locations to the assigned route. Other parameters that may be monitored by the Route Monitoring 120 may include the number of rims to be executed at a given time and their associated route maps, the number of students to be picked-up at each pick up points, their associated schedule and the status of the pick-up/drop-off points (i.e. if a school is closed or open).

The RTME 110 may also provide Weather Monitoring (122). In some embodiments, the weather data may be obtained using an API to a web-based weather data provider, such as OpenWeatherMap or similar. The weather data may also include high-resolution data, wherein it may be possible to identify specific roads or road sections under a particular weather event. In some embodiments, a generalized (averaged over a region) weather data set is used for all routes. In some embodiments, the weather data may comprise but is not limited to the temperature, the cloud coverage, the humidity, the atmospheric pressure, average wind direction and speed, the quantity and type of precipitation, or similar. In some embodiments, weather data concerning future runs may also be acquired. In some embodiments, the weather data may be entered manually by an authorized user via his/her user terminal 102 or via SMS, email or a messaging application, to name a few examples.

Similarly, the RTME 110 may also monitor traffic in real-time (traffic monitoring 124). In some embodiments, traffic may be monitored using a web-based API to access traffic data and/or authorized users (e.g., drivers and dispatchers) may manually enter traffic levels for given roads or road segments via their user terminals. In some embodiments, users may manually enter a traffic status update via their user terminal 102 or via SMS, email or a messaging application. In the case where the user terminal 102 is used, the GUI 118 may comprise a specially designed interface for traffic notifications.

The user monitoring (126) functionality may include, in some embodiments, user status (130) and schedule (132) monitoring. For example, some regulatory bodies may require bus drivers to only drive a certain amount of time or distance in a given time interval. The system may record the total driven distance/time of a driver via his user terminal 102. Moreover, as mentioned above, students/parents may also use their user terminals 102 to indicate that a student is missing school for a given time interval (afternoon, day, week, etc.). Other types of data, such as log-in/log-out times for all user types may also be recorded. The schedule monitoring (132) monitors any change the pre-registered school schedules. These may be used to deduce the presence or absence of students on a given bus route at a given day, as will be described below.

In some embodiments, vehicle monitoring (128) may involve, but is not limited to, monitoring the number of active buses available, including details about each type of vehicle (e.g., the number of passengers that may be carried safely, total effective range before refueling, etc.), their status (active, defective, out of service, crashed, etc.), operator licensing constraint, total mileage or similar. Authorized users (e.g., dispatcher, bus company operator) may be able to visualize the status of the entire bus fleet via their user interface 102. In some embodiments, automatic maintenance reminders may be sent to the authorized users via their user terminal 102, SMS, email or a messaging application. In some embodiments, a vehicle profile may be created for each bus wherein a history of past and latest maintenance reports is kept for reference purposes. In some embodiments, the RTME 110 may keep track in real-time, for all vehicles presently on the road, a list of other vehicles (one or more) that are the closest to it. The driver of any vehicle may easily access this information with his user terminal 102 to establish a communication link at any time with another driver that is in close proximity. For example, a driver may call another driver in close proximity to request help in case of an emergency (medical or otherwise), communicate a mechanical failure or coordinate a transfer of passengers. In some embodiments, the GUT 118 of each driver's user terminal 102 may comprise an option to easily identify the closest vehicle (or one of the closest) and instantly establish a communication link with the respective driver.

The RTME 110 may also, in some embodiments, provide a critical event monitoring (134) feature wherein events of pre-defined importance are reported. Usually these record critical events affecting the ability of one or more buses to complete its assigned route. Multiple factors may be in play as to why the vehicle is not able to continue on its run. For instance, the driver may be unable to continue driving the vehicle safely, for medical reasons (concerning the driver or one of the students) or similar. A disruptive event may have happened outside or inside the vehicle, such as a crash, a violent attack or similar. Other types of events may include, but are not limited to, traffic congestion, a traffic accident, severe weather conditions (e.g., snow storm, etc.), or similar. The time, location and nature for these events may be entered by an authorized user (e.g., bus driver) or deduced automatically from route monitoring 120. In the case of a medical emergency, the system may automatically communicate with the authorities, or may send a notification to other authorized users.

In some embodiments, the RTME 110 may also use statistical sampling methods to aggregate the plurality of data monitored over a given number of runs or over a certain time period. Furthermore, as explained above, this plurality of data monitored and accumulated by the RTME 110 may be visualized by authorized users, in some embodiments in real-time, individually or in the aggregate, using user terminal 102 and/or used autonomously by the RORE 114.

In some embodiments, the mapping engine (ME) 112 is operable to provide map generation (146) and versioned route map generation (148) features. Furthermore, ME 112 may be accessed by the RTME 110, the RORE 114 and/or directly by an authorized user via user terminal 102. To generate a route map, a set of currently designated pick-up and drop-off locations are provided as input. In some embodiments, the coordinates of the pick-up/drop-off locations are manually provided by authorized users (e.g., schoolboard administrator, dispatcher or driver). These coordinates may be in the form of GPS coordinates, or in the form of a street intersection, school name, address or point of interest. In some embodiments, the ME 112 may use a cloud-based mapping system API or applications (e.g., Google Directions API, TrackMatching REST API, or similar) to extract GPS coordinates if needed and generate the route map. Each route map may comprise a set driving direction, pick-up/drop-off locations, the number and names of students to be picked-up at each location and a schedule to follow (including pick-up/drop-off times). This route map may not only include driving directions for the driver to follow, but also information/annotation about different points of interest. The points of interest information may include the pick-up/drop-off points, but also information about traffic, road hazards and road safety tips to follow. After being generated, each route map is recorded on datastore 106. In some embodiments, the map model is recorded using a persistent (versioned) data type (versioned route map 148), meaning that it supports access to all map versions of the same route. Different implementations of a persistent data type may be used to store the route maps, including but not limited to a persistent binary search tree. Using a persistent data type has the advantage of being able to quickly and efficiently extract differences between successive versions of the same route map. These differences are also recorded and may be accessed by the RORE 114 to generate route modification suggestions.

Still referencing FIG. 1, the Route Optimization and Redistribution Engine (RORE) 114 is configured to utilize the plurality of data compiled by the RTME 110 to generate multiple optimization strategies in a semi-autonomous manner. These optimization strategies may be in the form of logistical optimization to any operational parameter controlling the efficiency of the school children transportation process. In some embodiments, optimization suggestions may be sent, via user terminal 102, to authorized users for approval before an optimization strategy is implemented by RORE 114. Furthermore, these optimization strategies may be done in real-time and/or after each run completion, triggered automatically when certain parameters are measured by the RTME 110 and/or may be requested by an authorized user via the user terminal 102.

In some embodiments, authorized users such as school board administrators or dispatchers may be authorized to manually control and modify the internal logic of the RORE 114 to meet specific requirements. For example, different school boards in different jurisdictions may have different regulations to follow. In such a case, certain types of optimization strategies may not be available for administrative or non-logistical reasons. These restrictions may be manually entered in the system and taken into account by the RORE 114. As such, certain types of optimization strategies may be avoided if necessary. In some embodiments, these strategies include, but are not limited to, route redistribution (136), run cancellation (138), pick-up time optimization (140), vehicle type optimization (142), using 3^{rd} party pickup services (144), and similar. The skilled artisan will understand that more optimization strategies may be devised and that multiple optimization strategies may be implemented by the RORE 114 simultaneously.

The route redistribution (136) strategy generally comprises merging one or more routes, completely or in part, in real-time or upon request from an authorized user. For example, this optimization strategy may be used to reduce the number of vehicles needed on the road at a given time. Another example is when a bus is not able to complete its assigned route. The remaining pick-up/drop-off locations may then be redistributed in real-time to other concurrently running bus routes so that all students arrive at school on time. A bulk pick-up may also be required where a bus has broken down and students currently boarded on this bus need to be reassigned to another bus in bulk. The new locations are added to the routes and fed into the ME 112 so that new route maps are generated. In some embodiments, the RORE 114 may iterate through multiple redistribution trials, retaining only the new set of route maps deemed the most efficient.

If needed (run cancellation 138), the RORE 114 may also determine that a run may have to be cancelled altogether if no pick-ups are needed at all pick-up locations. For example, a school may be closed on a given day resulting in all students not needing transportation that day. In such a situation, a run may be cancelled altogether and the remaining pick-up locations to be serviced (if any) may be redistributed to other routes temporarily (136). In such a case, the pickup points to be serviced are simply added to one or more route and a new set of optimized route map models are generated by the ME 112.

In some embodiments, a pick-up time optimization (140) procedure may be employed. For example, when a bus is expected, as calculated by the RORE 114, to arrive early or late at one or more designated pick-up locations, new pick-up times are automatically generated by the system and sent to the students assigned to these pick-up locations via their user terminals 102 or via SMS, email or a messaging application. This minimizes the time that a bus has to spend waiting at an empty pick-up location before continuing its run. The pick-up time changes may be computed in real-time or after one or more runs on a given route. In some embodiment, the RORE 114 may use school schedules to re-optimize bus routes for a given day. For example, one or more schools may be closed during a given day while others are opened (due to weather, or a professional activity day, or similar). This results in a sub-set of all students assigned to a bus route not needing bus transportation. The RORE 114 may then automatically generate new route maps, by using the plurality of optimization strategies explained above. One or more route maps may be modified so as to keep the transport process as efficient as possible.

In some embodiments, RORE 114 may determine that a smaller/larger bus may be needed (vehicle type optimization 142) for a given route if the currently expected number of children to be transported is smaller/larger than usual. Similarly, the RORE 114 may, under certain conditions, determine that a 3^{rd} party pickup service (144) may be used instead, if the currently available resources are unable to meet the required efficiency targets. For example, maybe a greater than usual number of buses are in maintenance and may not be used.

In some embodiments, the RORE 114 may optionally comprise a machine learning module (MLM) 150. This MLM 150 provides a more advanced analytic capability to the RORE 114 and is operable to utilize a plurality of machine learning algorithms (including deep-learning algorithms) to analyze, in real-time or after each run completion, the plurality of data acquired by the RTME 110 and to generate more advanced optimization strategies and recommendations.

In some embodiments, these machine learning algorithms may include supervised learning techniques and/or unsupervised learning techniques. Furthermore, they may include, but are not limited to, linear and/or non-linear regression, decision trees, principal component analysis, etc. Deep learning algorithms may be used, including, but not limited to, neural networks such as recurrent neural networks, recursive neural networks, feed-forward neural networks, convolutional neural networks, deep belief networks, and convolutional deep belief networks; multi-layer perceptrons; self-organizing maps; deep Boltzmann machines; and stacked de-noising auto-encoders. As such, the MLM 150, once trained, is designed to operate autonomously or semi-autonomously, with limited or without explicit user intervention.

For example, weather data accumulated by the RTME 110 may be processed by MLM 150 to find hidden correlations between weather patterns and the plurality of run parameters that measure the efficiency of the different runs made to completion (e.g., average measured speed vs expected speed, the number of route modifications, etc.). A given amount of precipitation (e.g., rain or snow) falling may have a recurring larger impact on the completion of certain routes vs others. The MLM 150 may use these correlations to generate more efficient route maps and route schedule. The MLM 150, having access to the large amount of data accumulated by the RTME 110, it is operable, once trained, to detect trends and autonomously discover optimization strategies that are too complex for other computer techniques or even human users. In some embodiments, the MLM 150 may be pre-trained on a previously obtained data set, or it may be configured to be in a “learning mode” during some initial trial period wherein authorized users may provide feedback to the system without using its optimization strategies.

In some embodiments, once RORE 114 (including MLM 150) has determined that one or more optimization strategies may be used, it may create a suggestion, notification to be sent to an authorized user via user terminal 102, email or messaging application for communication purposes and/or for approval. In some embodiments, the system may be operable to automatically make these changes without the pre-approval of an authorized user (e.g., dispatcher, driver).

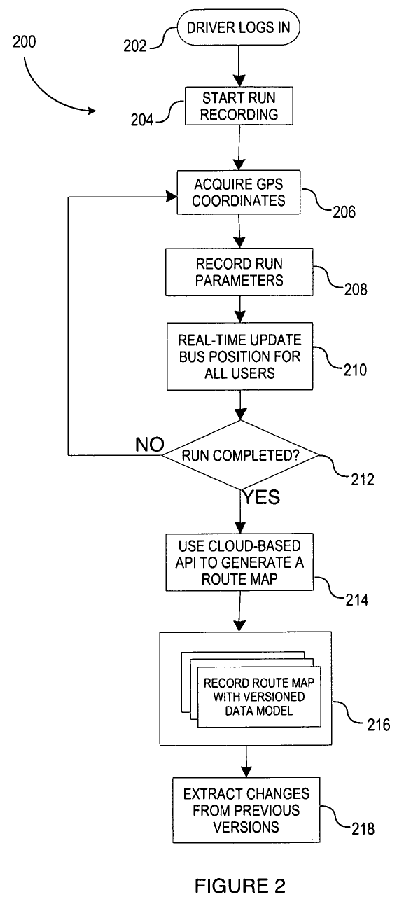

With reference to FIG. 2, and in accordance with one embodiment, an example of a route recording procedure 200, as mentioned above when discussing the route monitoring capabilities 120 of the RTME 110, will be described. In this example, the driver assigned to service a particular route logs in the system via his user terminal 102 (step 202). The route recording is activated once the bus leaves its assigned storage location (step 204). As the bus is servicing its assigned route, the GPS coordinates of the bus are continuously acquired (step 206). Other run parameters, as explained earlier (e.g., traffic, weather), may also be recorded (step 208). The updated position of the bus is sent to all authorized users (step 210), via their user terminal, and/or via short messaging service (SMS), emails, a messaging application (e.g., Messenger, WhatsApp Messenger, skype, or similar) or a push-to-talk (PTT) device (e.g., Kodiac API, etc.). The driver is free to depart from his assigned route map for multiple reasons (traffic, weather, hazards, etc.). All these deviations are recorded. Moreover, the driver is also free to manually add and/or remove pick-up and/or drop-off locations from his route. These changes may be done via his/her user terminal 102 or deduced by the RTME 110.

Once the driver has completed his/her assigned run (step 212), he/she may log out via user terminal 102. The ME (112) then feeds these data to a cloud-based API to generate a new, updated route map (step 214). The route map is recorded in the datastore 106 in a versioned data model, e.g. using a persistent data structure (step 216). The new route map is compared to the previous versions (if any), and changes from previous versions are extracted (step 218). Hence, each route map may be comprised of multiple versions, detailing all possible deviations that have occurred previously. Noted deviations may be accepted/authorized so that the revised route is now stored as the main or recommended route/itinerary, or rejected as a one-off deviation, for example, or as presenting other challenges/obstacles that may not have been apparent to the driver during the run. Other selective/approval/rejection measures may also be considered.

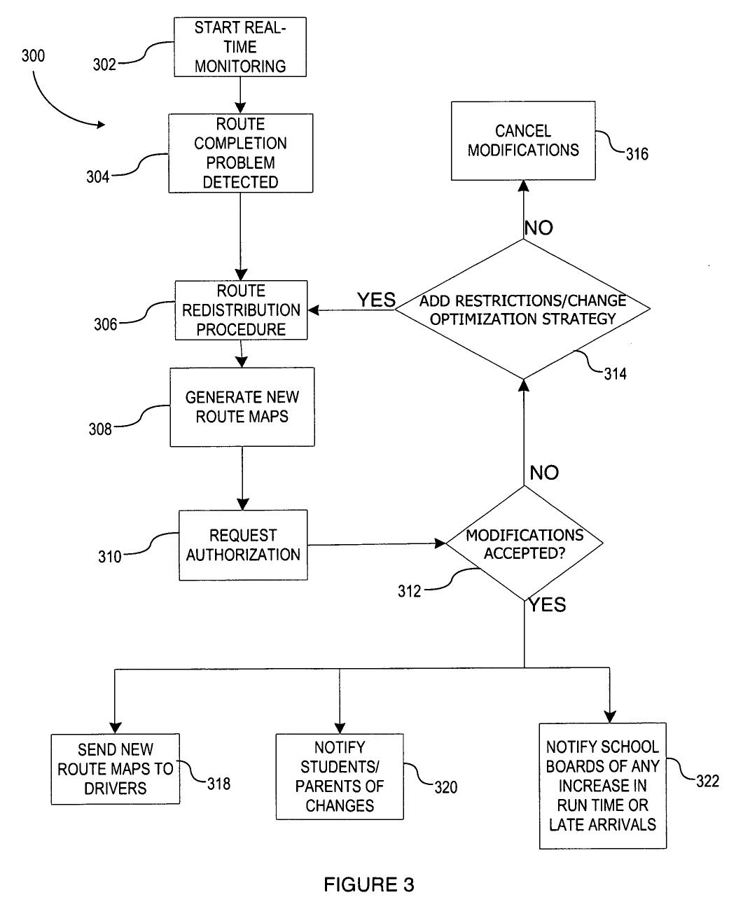

With respect to FIG. 3, and in accordance with one embodiment, an example of a real-time route redistribution procedure will be explained. For this particular example, the system is monitoring a plurality of bus runs (step 302) wherein one bus status indicator suddenly indicates that the vehicle is not able to complete its assigned route (step 304). In cases where the driver may be able to operate his user terminal, he or she may simply manually notify the system that he/she is unable to complete the route. In other cases, the system may automatically infer from its real-time monitoring of a bus status, position and speed, weather or traffic conditions, that the bus will not be able to complete its run, or complete it in reasonable time, for example. For example, the system may detect that a bus has stopped moving for a particularly long time and may automatically send a notification to the bus driver and/or dispatcher for confirmation.

In the currently discussed example, the chosen strategy is to redistribute the pick-up points of the cancelled route to the routes of other concurrently occurring runs (run redistribution procedure 306). For example, pick-up locations may be redistributed to other routes based on geographical proximity, complementary scheduling/itinerary timing, vehicle capacity, etc. Other optimization strategies may be employed without departing from the general scope of this invention. Immediately, new modified route maps for the remaining ongoing runs including the new pick-up points can be generated by the ME 112 (step 308). These include the updated expected pick-up times and arrival times for all affected students/parents. The route modification suggestions with the new route maps are automatically sent to authorized users, in this case the dispatcher and/or individual drivers via their user terminals (step 310). If the route modification suggestions are accepted (step 312), the new route maps are automatically sent to the concerned drivers (step 318), the students and parents are automatically notified of the changes (step 320) and the authorized school board administrators are automatically notified of any increase in run time and/or expected late bus arrivals (step 322). In the case wherein a route modification is refused, authorized users may demand (step 314) that the system try optimizing the remaining routes once more, but with added restrictions or demand other optimization strategies be employed (e.g., cancelling other routes, adding/decreasing the number of buses, as explained above). In other cases, the optimizations may be cancelled altogether (step 316).

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become apparent to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims. Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the disclosure.

What is claimed is:

1. A vehicular route management system for managing a set of predefined routes to be repetitively executed by a corresponding set of vehicles, the system comprising:
a respective onboard user terminal operable from within each of the vehicles and operably linked to a corresponding global positioning system (GPS) receiver to acquire route tracking data as a given vehicle travels along a given predefined route;
a network-accessible server operatively associated with a communication interface, a digital data processor and a data storage device, said server directly or indirectly linking with each said onboard user terminal via said communication interface to process said route tracking data to automatically:
generate a digital route mapping for said given route based on said route tracking data;
identify deviations in said digital route mapping from said given predefined route representative of corresponding route deviations executed by said given vehicle during travel along said given predefined route;
generate a revised digital version of said given route based on said identified deviations; and
dispatch said revised digital version to said onboard user terminal to be followed during subsequent travel along said given predefined route.

2. The system of claim 1, wherein said server is operable to generate and store said revised digital version of said given route as a persistent data structure.

3. The system of claim 2, wherein said persistent data structure is a persistent binary search tree.

4. The system of claim 1, wherein each said given predefined route comprises a plurality of pick-up locations and at least one drop-off location.

5. The system of claim 4, wherein the system is a school bus route management system, wherein each of said pick-up locations is digitally associated with at least one student profile corresponding with a student to be picked up at said pick-up location.

6. The system of claim 1, wherein said GPS receiver is integrated within said onboard user terminal.

7. The system of claim 1, wherein said onboard user terminal comprises a graphical user interface (GUI) operable to display elements of said given route.

8. The system of claim 1, wherein said onboard user terminal is operable to deny said revised digital version in favour of a previous version.

9. The system of claim 1, wherein said revised route is selectively dispatched in response to an administrator action interactively executed via said server.

10. A computer-implemented process for managing a set of predefined routes to be repetitively executed by a corresponding set of vehicles, the process comprising:
acquiring, via an onboard user terminal, digital route tracking data as a given vehicle travels along a given predefined route;
generating, via a server communicatively linked to said onboard user terminal, a digital route mapping for said given route based on said route tracking data;
automatically identifying deviations in said digital route mapping from said given predefined route representative of corresponding route deviations executed by said given vehicle during travel along said given predefined route;
automatically generating a revised digital version of said given route based on said identified deviations; and
communicatively dispatching said revised digital version to said onboard user terminal to be followed during subsequent travel along said given predefined route.

11. The process of claim 10, wherein said revised digital version of said given route is stored as a persistent data structure.

12. The process of claim 11, wherein said persistent data structure is a persistent binary search tree.

13. The process of claim 10, wherein each said given predefined route comprises a plurality of pick-up locations and at least one drop-off location.

14. The process of claim 13, wherein the process is a school bus route management process, wherein each of said pick-up locations is digitally associated with at least one student profile corresponding with a student to be picked up at said pick-up location.

15. The process of claim 13, wherein said automatically identifying deviations in said digital route mapping comprises automatically identifying a travel path deviation between two successive pick-up locations.

16. The process of claim 13, wherein said automatically identifying deviations in said digital route mapping comprises automatically identifying a re-ordering at least two of said pick-up locations thereby resulting in a corresponding travel path deviation.

17. The process of claim 10, wherein said revised digital version is selectively denied in favour of a previous version via a user interface of said onboard user terminal.

18. The process of claim 10, wherein said revised route is selectively dispatched in response to an administrator action interactively executed via said server.

19. A vehicular route management system for managing a set of predefined routes to be repetitively executed by a corresponding set of vehicles, the system comprising:
a plurality of onboard user terminals operable from within respective vehicles as they travel on respective routes, wherein each of said terminals is operatively associated with:
a global positioning system (GPS) receiver to track a corresponding vehicle as it travels along a designated route;
a graphical user interface (GUI) to preview and display vehicular travel along said designated route; and
a wireless communication interface;
a network-accessible server operatively associated with a digital data processor, a data storage device and an input interface;
wherein said data storage device has stored in association therewith designated route data representative of each of said respective routes and defining for each one thereof a prescribed vehicle, a plurality of pick-up locations, at least one drop-off location and a predefined geographic path mapping sequence and timing therebetween;
wherein, upon identification that a given prescribed vehicle will not complete a given designated route, said digital processor automatically:
identifies affected pick-up locations associated with said given designated route;
identifies at least one distinct route associated with a distinct vehicle that is alterable to take on said affected pick-up locations;
temporarily redistributes said affected pick-up locations amongst said at least one distinct route by automatically redefining said predefined geographic path mapping sequence respectively associated therewith to include said affected pick-up locations; and
dispatches each said automatically redefined geographic path mapping sequence to each said distinct vehicle.

20. The system of claim 19, wherein said digital data processor redistributes said affected pick-up locations based at least in part on at least one of a geographical proximity of said distinct route to said affected pick-up locations, an available transport capacity of said distinct vehicle or a temporal availability of said distinct vehicle as determined from said timing of said designated route associated therewith.
